(19) United States
(12) Patent Application Publication
(10) Pub. No.: US 2016/0037602 A1
(43) Pub. Date: Feb. 4, 2016

(54) LIGHTING SYSTEM AND METHOD

(71) Applicant: Lee Anthony NICHOLLS, Christchurch (NZ)

(72) Inventor: Lee Anthony NICHOLLS, Christchurch (NZ)

(21) Appl. No.: 14/776,680

(22) PCT Filed: Mar. 12, 2014
(86) PCT No.: PCT/NZ2014/000035

§ 371 Date: Sep. 14, 2015

(30) Foreign Application Priority Data
Mar. 12, 2013 (NZ) 608114

(51) Int. Cl. H05B 33/08; F21S 9/02; H02J 9/06; F21K 99/00

(52) U.S. Cl. CPC H05B 33/0842; F21K 9/135; F21S 9/022; H02J 9/06; F21Y 2101/02

(57) ABSTRACT

According to one aspect of the present invention there is provided a removable light source including a light emitting source, a connector for electrically connecting the removable light source to a mains lighting circuit, a secondary power source and a control circuit configured to receive an on/off signal, whereby the control circuit is configured to power the light emitting source on if power is being supplied to the removable light source by the mains lighting circuit, OR power is provided by the secondary power source and the control circuit receives an on signal and power the light emitting source off if power being supplied to the removable light source by the mains lighting circuit ceases and the control circuit does not receive an on signal, OR power is being supplied by the secondary power source and the control circuit receives an off signal.

### STATEMENT OF CORRESPONDING APPLICATIONS

This application is based on New Zealand Patent Application Number 608114, the entire contents of which are incorporated herein by reference.

### TECHNICAL FIELD

The present invention relates to improvements in lighting systems and in particular to emergency lighting systems.

### BACKGROUND ART

Emergency lighting systems are typically implemented in commercial buildings which have no source of natural light, or which house essential services, such as hospitals or the like. In other buildings only ‘Exit’ lighting indicating safe exit from a building may be powered from an emergency lighting system.

One reason for this is that installing an emergency lighting system is prohibitively expensive in most situations. The expense is more often than not due to the need for large battery banks and/or backup generators for powering the emergency lighting system when the mains power is no longer available.

Another issue with many emergency lighting systems is that a mains failure and switching system is required to detect the failure of the mains supply and to switch to supplying power to the lighting system by way of a secondary power source, such as batteries and/or generator(s).

Many emergency lighting systems employ both a mains power lighting network and an emergency lighting network. The reason for this is that lower wattage bulbs can be used in the emergency lighting network for when power is being supplied by battery and/or generator(s). This provides an emergency lighting network which is tolerant to longer periods where mains power is unavailable. However, this comes at the expense of separate wiring, light fittings and bulbs over the existing mains lighting circuit. Furthermore, emergency lighting systems that are separate to the mains lighting circuit require frequent testing to ensure the system is operational and no bulbs require replacement.

It is an object of the present invention to address the foregoing problems or at least to provide the public with a useful choice.

All references, including any patents or patent applications cited in this specification are hereby incorporated by reference. No admission is made that any reference constitutes prior art. The discussion of the references states what their authors assert, and the applicants reserve the right to challenge the accuracy and pertinency of the cited documents. It will be clearly understood that, although a number of prior art publications are referred to herein, this reference does not constitute an admission that any of these documents form part of the common general knowledge in the art, in New Zealand or in any other country.

Throughout this specification, the word “comprise”, or variations thereof such as “comprises” or “comprising”, will be understood to imply the inclusion of a stated element, integer or step, or group of elements integers or steps, but not the exclusion of any other element, integer or step, or group of elements, integers or steps.

Further aspects and advantages of the present invention will become apparent from the ensuing description which is given by way of example only.

### DISCLOSURE OF THE INVENTION

According to one aspect of the present invention there is provided a removable light source including:
a light emitting source;
a connector for electrically connecting the removable light source to a mains lighting circuit,
a secondary power source; and
a control circuit configured to receive an on/off signal,
   whereby the control circuit is configured to:

power the light emitting source on if:
a) power is being supplied to the removable light source by the mains lighting circuit, OR
b) power is provided by the secondary power source and the control circuit receives an on signal,

power the light emitting source off if:
c) power being supplied to the removable light source by the mains lighting circuit ceases and the control circuit does not receive an on signal, OR
d) power is being supplied by the secondary power source and the control circuit receives an off signal.

In preferred embodiments the removable light source is a light bulb configured to fit into a standard light fitting. In the context of the present invention a light bulb defines a self contained lighting assembly, which includes, but should not be limited to:
at least one light emitter;
a body portion;
a connector, non limiting examples of which include bayonet, push fit and screw types; and
any electronic circuitry associated with the at least one light emitter.

Preferably the at least one light emitter is a plurality of light emitting diodes (LEDs).

In some preferred embodiments the light emitter may be a high efficiency light source, non-limiting examples of which include fluorescent bulbs, LED's, HID bulbs, Sodium vapor bulbs or the like.

In preferred embodiments the control circuit is configured to power on each of the plurality of light emitting diodes when the removable light source is supplied by the mains lighting circuit.

In preferred embodiments the control circuit is configured to power on one or more of the plurality of light emitting diodes when the removable light source is supplied by the secondary power source.

A person skilled in the art would understand that under non-emergency situations a light source is expected to provide a high level of luminous output to provide sufficient luminous intensity for reading or the like. In situations where emergency lighting is activated it is only necessary to provide sufficient luminous intensity to enable a person to navigate without risk of injury to themselves or others.

A mains lighting circuit describes a wired lighting network which is powered from a mains power source as would typically be found in a structure. A mains lighting circuit will typical include the physical cabling, light switches, light fittings and the like in a building. Any number of mains lighting circuits exist and the present invention should not be seen as being limited to any particular type of mains lighting circuit. Non limiting examples on mains lighting circuits include, but should not be limited to:
self contained remote lighting circuits, for example in an isolated structure such as a ship or large vehicle;
the lighting circuit in a residential building;
the lighting circuit in a commercial building;
the lighting circuit in a mine or other man-made structure.

A main power source should be understood to include any primary source of power, non limiting examples of which include: a reticulated electricity supply, solar power, generator(s), battery banks or the like.

In preferred embodiments the secondary power source is a battery.

Preferably the battery is rechargeable.

In especially preferred embodiments the rechargeable battery is charged when the removable light source is supplied by the mains lighting circuit.

Preferably the control circuit is configured to charge the rechargeable battery when the removable light source is supplied by the mains lighting circuit.

Preferably the battery is replaceable. If the mains lighting circuit is unable to provide power for an extended period of time the rechargeable battery may become flattened. It would be useful to be able to manually replace the battery in this situation.

In preferred embodiments the removable light source is configured to allow the rechargeable battery to be removed and replaced.

In preferred embodiments the on/off signal that the control circuit is configured to receive may include one or more of, but should not be limited to:
a physical on/off switch on the bulb;
a radio signal; and/or
a signal transmitted over the existing mains lighting circuit wiring.

In some preferred embodiments the control circuit monitors for the on/off signal and in the absence of any signal the light emitting source defaults to an on state. It will be appreciated that in an emergency situation whereby the source of the on/off signal is damaged and stops working the light emitting source should preferably be activated.

According to a second aspect of the present invention there is provided a process of controlling a removable light source substantially as described above, the removable light source including a light emitting source, a secondary power source, a connector for electrically connecting the removable light source to a mains lighting circuit and a control circuit configured to receive an on/off signal, the process including the steps of:

the control circuit powering the light emitting source on if:
a) power is being supplied to the removable light source by the mains lighting circuit, OR
b) power is provided by the secondary power source and the control circuit receives an on signal,

the control circuit powering the light emitting source off if:
c) power being supplied to the removable light source by the mains lighting circuit ceases and the control circuit does not receive an on signal, OR
d) power is being supplied by the secondary power source and the control circuit receives an off signal.

Preferably the process of controlling the removable light source includes the step of communicating an on/off signal to the control circuit, wherein the on/off signal is communicated by way of one or more of:
a physical on/off switch on the bulb;
a radio signal; and/or
a signal transmitted over the existing mains lighting circuit wiring.

In especially preferred embodiments the on/off signal is communicated over the existing mains lighting circuit wiring.

In preferred embodiments the on/off signal is a series of pulses transmitted over the existing mains lighting circuit wiring.

In preferred embodiments the process of controlling the removable light source includes the step of monitoring the presence of power to the mains lighting system by way of a monitoring circuit.

Preferably if the mains lighting system power is detected as being unavailable by the monitoring circuit an on signal is communicated from a command circuit to the control circuit of each removable light source.

Preferably the on signal from the command circuit is switched to an off signal after a pre-defined period of time.

In preferred embodiments the existing light switches in the mains lighting circuit can be used to power individual removable light sources on and off. Typically a mains lighting circuit will include an on/off switch for manually connecting power from the mains lighting circuit to one or more removable light sources. When the mains lighting circuit is unable to provide power an on/off signal communicated by way of the main lighting circuit wiring will be blocked from being received by a removable light sources if the mains lighting circuit switch to that removable light source is switched off. When the light switch is switched on the signal is received by the removable light sources and the removable light sources will switch on and power themselves from their respective secondary power source. In this manner the mains lighting system of the present application can be manually operated with the same manual switches as the mains lighting circuit.

According to a third aspect of the present invention there is provided a lighting circuit monitoring and control system, the system including:
a mains lighting circuit;
one or more removable light sources substantially as described above, electrically connected to the mains lighting circuit, the one or more removable light sources including, a light emitting source, a secondary power source, a connector for electrically connecting the removable light source to a mains lighting circuit and a control circuit configured to receive an on/off signal;
a command circuit configured to provide an on/off signal to the control circuits of the one or more removable light sources,

wherein the light emitting source of any one of the one or more removable light sources is powered on if:
a) power is being supplied to the removable light source by the mains lighting circuit, OR
b) power is provided to the removable light source by a respective secondary power source and the command circuit provides an on signal to the removable light source, and

wherein the light emitting source of any one of the one or more removable light sources is powered off if:
c) power being supplied to the removable light source by the mains lighting circuit ceases and an on signal is not provided to the removable light source by the command circuit, OR
d) power is being supplied to the removable light source by a respective secondary power source and the command circuit provides an off signal to the removable light source.

In preferred embodiments the command circuit incorporates, or communicates with, a monitoring circuit which is configured to monitor for the presence of power to the mains lighting circuit.

In preferred embodiments the monitoring circuit monitors the presence of power to the mains lighting circuit at a location which would typically be permanently powered from the same power source as the mains lighting circuit.

In one embodiment the presence of power to the mains lighting circuit may be monitored at a permanently powered appliance outlet, non-limiting examples include an outlet supplying a fridge or freezer.

In other embodiments the presence of power to the mains lighting circuit may be monitored at a permanent power connection supplying the mains lighting circuit, non limiting examples include connection at a mains power distribution panel, or fuse board or the like.

Preferred embodiments of the present invention may provide a number of advantages over the prior art, non limiting examples include:

the ability to implement an emergency lighting system at a lower cost than existing hardwired emergency lighting systems;

future proofing by way of expandability, whereby the extent of an emergency lighting system can be increased by simply replacing standard light bulbs with removable light sources of the present application;

the ability to manually operate an existing lighting circuit with manual on/off switches regardless of whether the circuit is operating under emergency conditions or under normal operating conditions; and

a longer duration emergency runtime over systems which use regular bulbs due to differing bulb wattages (luminous intensities) when running in normal mode or emergency mode.

### BRIEF DESCRIPTION OF THE DRAWINGS

Further aspects of the present invention will become apparent from the ensuing description which is given by way of example only and with reference to the accompanying drawings in which:

FIG. 1 is a perspective view of a number of a removable light source in accordance with one preferred embodiment of the present invention;

FIG. 2 is an exploded view of the removable light source of FIG. 1, and

FIG. 3 is a schematic view of a lighting circuit monitoring and control system in accordance with a preferred embodiment of the present invention.

### BEST MODES FOR CARRYING OUT THE INVENTION

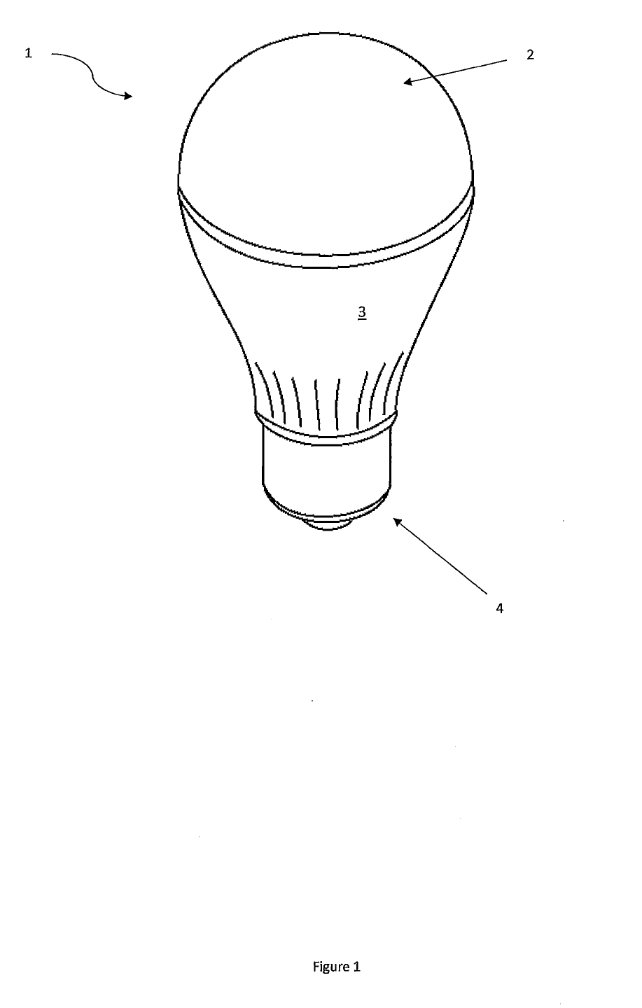

With respect to FIG. 1 there is shown removable light source as generally indicated by arrow 1. Removable light source 1 includes a light emitting source 2, a housing 3 which contains a secondary power source; and a control circuit (neither of which are shown in FIG. 1).

Removable light source 1 is configured to electrically connect to a mains lighting circuit by way of connector 4. Connector 4 may take the form of any one of many well known connector types, such as bayonet, screw in or pin types. The external configuration of the removable light source 1 shown in FIG. 1 should also not be seen as being limiting. The removable light source 1 could take any number of well known bulb form factors, such as MR12, MR16, standard globes or the like.

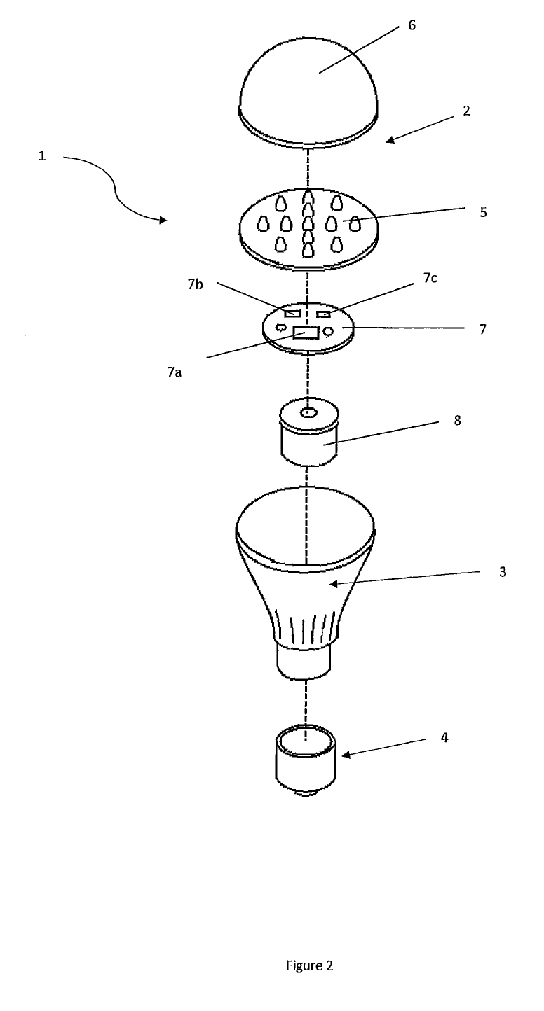

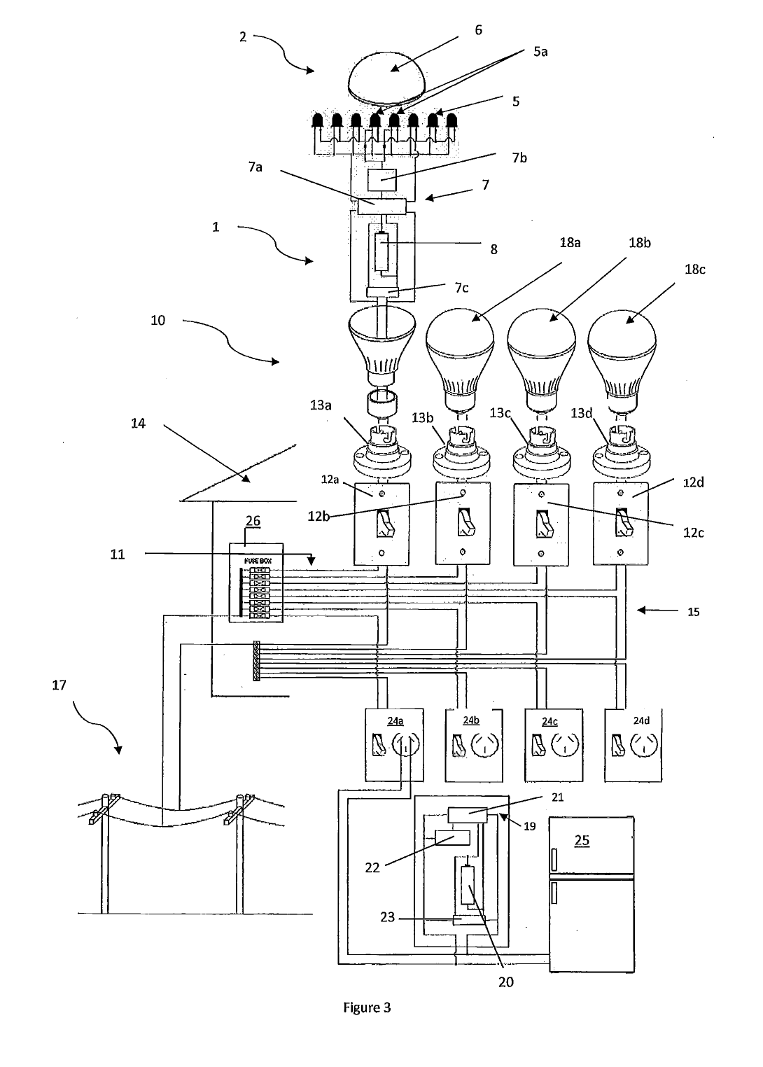

With respect to FIGS. 2 and 3 there is shown an exploded view of the removable light source 1 of FIG. 1. Removable light source 1 includes light emitting source 2 having cover 6. Enclosed within housing 3 are LEDs 5, control circuit 7 and a secondary power source in the form of rechargeable battery 8 to be accessed. This is useful for replacement of faulty components. Removal of cover 6 from housing 3 allows LEDs 5, control circuit 7 and rechargeable battery 8. In this manner the rechargeable battery can be replaced if necessary. In addition, the LEDs 5 and/or control circuit 7 can be replaced in the event of failure. Control circuit 7 includes a switching circuit 7a, an LED driver circuit 7b and battery charger 7c for maintaining the battery 8 charge when mains power is present.

With respect to FIG. 3 there is shown a schematic view of a lighting circuit monitoring and control system as generally indicated by arrow 10. Lighting circuit monitoring and control system 10 includes a mains lighting circuit 15 comprising physical cabling 11, fuse board 26, light switches (12a, 12b, 12c and 12c), light fittings (13a, 13b, 13c and 13d) in residential building 14. The mains lighting circuit 15 is powered from reticulated electricity supply 17. Lighting circuit monitoring and control system 10 includes removable light sources 1, 18a, 18b and 18c and command circuit 19. Command circuit 19 includes internal rechargeable battery 20, a monitoring circuit 22, a signal generator 21 for transmitting an on/off signal to the removable light sources 1, 18a, 18b and 18c and battery charger 23 for maintaining the battery 20 charge when mains power is present. Command circuit 19 is connected to a permanently powered outlet which is supplied by the same reticulated electricity supply 17 as the mains lighting circuit 15. In the example, command circuit 19 is powered from the same outlet 24a as is supplying refrigerator 25. Alternatively the Command circuit 19 may be powered by way of direct connection to fuse board 27.

For clarity of understanding the operation of the lighting circuit monitoring and control system 10 will now be described under both normal operating conditions when reticulated electricity supply 17 is powered on, and under emergency conditions when reticulated electricity supply 17 is powered off.

Under normal operating conditions individual removable light sources 1, 18a, 18b and 18c are operated by manually switching respective light switches 12a, 12b, 12c and 12d. When power is connected by way of a manual switch 12a, 12b, 12c or 12d control circuit 7 (only shown in relation to removable light source 1) provides power to all LEDs 5 and battery charger 7c charges battery 8. Also under normal operating conditions command circuit 19 monitors the presence of reticulated electricity supply 17 by way of monitoring circuit 22. Because command circuit 19 shares the same power outlet 24a as refrigerator 25, which is unlikely to be switched off, power is only likely be disconnected when the reticulated electricity supply 17 is lost. Whilst the reticulated electricity supply 17 is present battery charger 23 maintains the charge of battery 20.

Under emergency conditions in which reticulated electricity supply 17 is absent, command circuit 19 is powered from battery 20 and monitoring circuit 22 detects the reticulated electricity supply 17 as being absent. Absence of reticulated electricity supply 17 results in signal generator 21 transmitting an on signal to the removable light sources 1, 18a, 18b and 18c.

Initially this may be by way of a radio signal so as to activate removable light sources 1, 18a, 18b and 18c regardless of switch 12a, 12b, 12c and 12d positions. The command circuit 19 maintains an initial on time of 10 minutes, after which the signal generator 21 transmits an off signal. The signal generator 21 will also revert to sending an off signal in the event that the reticulated electricity supply 17 is restored.

Individual removable light sources 1, 18a, 18b and 18c control circuit 7 receive the initial signal and switching circuit 7a provides power to emergency LEDs 5a by way of rechargeable battery 8, thereby providing a low luminosity emergency light output.

After a pre-determined time, for example 10 minutes, the command circuit 19 signal generator 21 stops sending the initial signal. If the reticulated electricity supply 17 is still absent, the signal generator 21 sends a continuous pulsed signal over physical cabling 11. If wall switches 12a, 12b, 12c and 12d are in an off position, removable light sources 1, 18a, 18b, 18c do not receive the pulsed signal and are powered off. The reason the pulsed signal is not received is due to the mains circuit supplying the removable light sources 1, 18a, 18b, 18c not forming a closed electrical loop due to the wall switches 12a, 12b, 12c and 12d being in an off position. If manual wall switches 12a, 12b, 12c and 12d are in an on position, the pulsed signal is received by removable light sources 1, 18a, 18b, 18c and they are powered on. The reason the pulsed signal is received is due to the mains circuit supplying the removable light sources 1, 18a, 18b, 18c forming a closed electrical loop. Removable light sources 1, 18a, 18b and 18c detect the pulsed signal by way of switching circuit 7a. When removable light sources 1, 18a, 18b and 18c are powered from rechargeable battery 8 only LEDs 5a are powered on. This reduces the overall power consumption of the system.

An option on some removable light sources 1, 18a, 18b and 18c is the addition of a manual signal such as an on off switch on a removable light source 1, 18a, 18b and 18c. This allows the removable light source 1, 18a, 18b and 18c to be removed from respective light fittings (13a, 13b, 13c and 13d) and powered on and off manually. This allows a removable light source to be used as a portable flashlight.

Aspects of the present invention have been described by way of example only and it should be appreciated that modifications and additions may be made thereto without departing from the scope thereof as defined in the appended claims.

1-17. (canceled)

18. A removable light source including:
a light emitting source;
a connector for electrically connecting the removable light source to a mains lighting circuit,
a secondary power source; and
a control circuit configured to receive an on/off signal through the connector,
whereby the control circuit is configured to:
power the light emitting source on if:
power is being supplied to the removable light source by the mains lighting circuit, OR
power is provided by the secondary power source and the control circuit receives an on signal through the connector,
power the light emitting source off if:
power being supplied to the removable light source by the mains lighting circuit ceases and the control circuit does not receive an on signal through the connector, OR
power is being supplied by the secondary power source and the control circuit receives an off signal through the connector.

19. The removable light source as claimed in claim 18 wherein the connector is configured to fit into a standard light fitting.

20. The removable light source as claimed in claim 18 wherein the at least one light emitter is a plurality of light emitting diodes (LEDs).

21. The removable light source as claimed in claim 20 wherein the control circuit is configured to power on each of the plurality of light emitting diodes when the removable light source is supplied by the mains lighting circuit.

22. The removable light source as claimed in claim 20 wherein the control circuit is configured to power on one or more of the plurality of light emitting diodes when the removable light source is supplied by the secondary power source.

23. The removable light source as claimed in claim 18 wherein the secondary power source is a battery.

24. The removable light source as claimed in claim 23 wherein the battery is rechargeable.

25. The removable light source as claimed in claim 23 wherein the removable light source is configured to allow the battery to be removed and replaced.

26. The removable light source as claimed in claim 18 wherein the on/off signal that the control circuit is configured to receive is a signal transmitted over an existing mains lighting circuit wiring.

27. A process of controlling a removable light source, the removable light source including a light emitting source, a secondary power source, a connector for electrically connecting the removable light source to a mains lighting circuit and a control circuit configured to receive an on/off signal, the process including the steps of:
the control circuit powering the light emitting source on if:
power is being supplied to the removable light source by the mains lighting circuit, OR
power is provided by the secondary power source and the control circuit receives an on signal through the connector,
the control circuit powering the light emitting source off if:
power being supplied to the removable light source by the mains lighting circuit ceases and the control circuit does not receive an on signal through the connector, OR
power is being supplied by the secondary power source and the control circuit receives an off signal through the connector.

28. The process as claimed in claim 27 including the step of communicating an on/off signal to the control circuit, wherein the on/off signal is communicated by way of one or more of:
a physical on/off switch on the removable light source;
a radio signal; and/or
a signal transmitted over the existing mains lighting circuit wiring.

29. The process as claimed in claim 27 including the step of charging the rechargeable battery when the removable light source is supplied by the mains lighting circuit.

30. The process as claimed in claim 28 whereby the on/off signal is a series of pulses transmitted over the existing mains lighting circuit wiring.

31. The process as claimed in claim 27 including the step of monitoring the presence of power to the mains lighting system by way of a monitoring circuit.

32. A lighting circuit monitoring and control system, the system including:
a mains lighting circuit;
one or more removable light sources, electrically connected to the mains lighting circuit, the one or more removable light sources including, a light emitting source, a secondary power source, a connector for electrically connecting the removable light source to a mains lighting circuit and a control circuit configured to receive an on/off signal through the connector;
a command circuit configured to provide an on/off signal to the control circuits of the one or more removable light sources through the mains lighting circuit,
wherein the light emitting source of any one of the one or more removable light sources is powered on if:
power is being supplied to the removable light source by the mains lighting circuit, OR
power is provided to the removable light source by a respective secondary power source and the command circuit provides an on signal through the mains lighting circuit to the removable light source, and
wherein the light emitting source of any one of the one or more removable light sources is powered off if:
power being supplied to the removable light source by the mains lighting circuit ceases and an on signal is not provided to the removable light source by the command circuit, OR
power is being supplied to the removable light source by a respective secondary power source and the command circuit provides an off signal to the removable light source through the mains lighting circuit.

33. The system as claimed in claim 32 wherein the command circuit includes a monitoring circuit which is configured to monitor for the presence of power to the mains lighting circuit at a location which would typically be permanently powered from the same power source as the mains lighting circuit.
